(19) United States
(12) Patent Application Publication
(10) Pub. No.: US 2009/0272501 A1
(43) Pub. Date: Nov. 5, 2009

(54) TENSIONING PIN FOR SHUTTER SYSTEMS

(75) Inventors: William S. Lee, Hollister, CA (US); Lin Yang, San Jose, CA (US)

Correspondence Address: IPLO-Intellectual Property Law Offices, 95 SOUTH MARKET STREET SUITE 570, San Jose, CA, 95113, US

(73) Assignee: San Benito Shutter, Inc., Hollister, CA (US)

(21) Appl. No.: 12/112,284

(22) Filed: Apr. 30, 2008

(51) Int. Cl. E05F 11/02

(52) U.S. Cl. 160/188

(57) ABSTRACT

A tensioning pin system (10) is provided for use in shutter-louver assemblies (12). The major component of the system (10) is a tensioning pin (50) in two mating parts; a pin member (52) and a ferrule member (54) which fit together and rotate with respect to one another. The pin member (52) is lodged within a louver slat (16) while the ferrule member (54) is firmly embedded into the shutter frame (14). The tensioning pin (50) maintains rotational tension for placement of the louver slat (16) and lateral separation between the louver slat (16) and the frame (14). A preferred interface between the pin member (52) and the ferrule member (54) includes an annular protrusion (80) mating with a catch channel (74) while alternate tension interfaces incorporate varying gradients on one of the members with a bead ring on the other member.

### TECHNICAL FIELD

The present invention relates generally to building constructions and more particularly to shutter systems and tensioning pins for louvers used therein.

### BACKGROUND ART

Building shutters, sometimes referred to as stationary shutters, plantation shutters and the like, are desirable and valuable additions to many homes and other buildings. Shutters provide light and vision control as well as decorative touches to construction.

Typical shutter systems have a plurality of laterally arrayed louver slats (of wood or synthetic materials) pivotally mounted between vertical support frames. The louvers typically pivot on pins which extend into the lateral frame members, with the pins either being integral to the louvers or separate components. In order to maintain proper separation and tension on the louvers, one or more tensioning bolts extends across between the frame members and is tightened to a desired separation and tension level after installation.

In an effort to minimize the need for tensioning bolts (and the unsightly exposed ends on the exterior of the frame members) tensioning pins have been developed to extend only a limited distance into the side members and the louvers. However, these have not been entirely satisfactory in all cases due to slippage and occasional disengagement with one or the other component.

Accordingly, room for improvement exists for methods for providing shutter louvers with improved stability and tension. There is thus a need and desire for improved tensioning pins for installing and supporting shutter louvers.

### DISCLOSURE OF INVENTION

Accordingly, it is an object of the present invention to provide an improved tensioning pin system for use in shutter construction.

Another object of the invention is to provide a tensioning pin which provides solid seating with properly tensioned freedom of rotation, facilitating smooth, controllable pivoting of the associated louvers.

A further object of the present invention is to provide a two part tension pin, with a ferrule member seated into the frame member and a pivot pin member extending into the louver slat, the tensioning pin rotating within the ferrule.

Yet another object of one embodiment of the present invention is to provide a method of achieving constant tension and spacing between louver and frame members.

An additional object of the present invention is to provide a louver rotation system which is held together internally, once assembled.

Briefly, one preferred embodiment of the present invention is a tensioning pin system for use in shutter-louver assemblies. The preferred tensioning pin includes a pin member for engaging with the louver slat and a ferrule member for engaging the corresponding frame. The tensioning pin member includes a cylindrical post having an annular catch channel. The cylindrical post slides into a center bore of the ferrule until an annular protrusion, formed in the center bore, snaps into and engages the catch channel, thus securing the two members together longitudinally and defining a rotation surface therebetween. The pin member is firmly embedded into the louver slat and the ferrule member is firmly secured to the frame, but the pin is free to rotate (under frictional tension) within the ferrule so the louver slat can be rotated to open and close the shutters.

An advantage of the present invention is that it has a defined and limited friction zone during rotation and thus minimizes binding during use.

An additional advantage of the invention is that it maintains longitudinal spacing between the louver slat and the frame.

A further advantage of the invention is that, once assembled, the pin and ferrule are held together internally, to avoid loss of tension over time,

Another advantage is that the relatively tight fit between the ferrule and the pin member provides some resistance to rotation (frictional rotational tension) and keeps the louvers from being too loose.

Still another advantage of the present invention is the minimization of rotational contact surface leads to greater consistency and minimizes binding during use.

Yet another advantage of one embodiment of the invention is that a slight gradient on the cylindrical post facilitates a sliding fit with the ferrule member which gets tighter with greater degrees of engagement, thus resulting in a more secure mating between the portions of the tensioning pin.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 (prior art) is a perspective view of a typical shutter—louver assembly, showing the various components;

FIG. 2 is an exploded side elevational view (partially cut away) of a preferred embodiment of the tension pin of the present invention;

FIG. 3 is a cross sectional view of the inventive tensioning pin as installed in a shutter—louver assembly;

FIG. 4 is a cross sectional view illustrating the interior of an alternate ferrule member, showing an annular bead ring;

FIGS. 5a, 5b and 5c are fanciful, exaggerated views of the surface of three alternate cylindrical post members, showing alternate gradients for use with the invention.

### BEST MODE FOR CARRYING OUT THE INVENTION

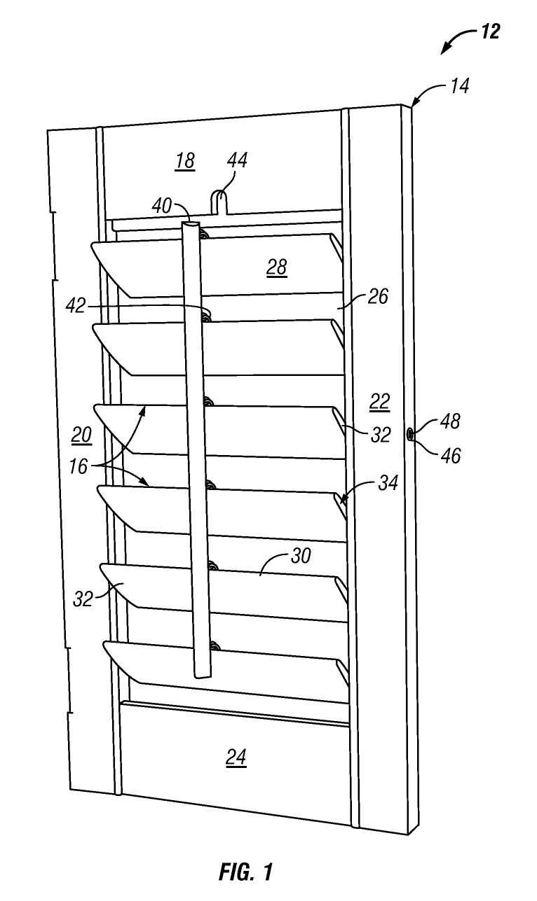

The present invention is a tensioning pivot pin system for use in shutter assemblies and a preferred embodiment thereof is referred to in the discussion and drawing by the general reference character 10. The preferred embodiment of the tensioning pivot pin 10 is intended for use in a shutter—louver system 12, as illustrated in FIG. 1.

The shutter system 12 is shown as including an outer frame 14 and a plurality of louver slats 16. The outer frame 14 includes a top frame panel 18, a left side panel 20, a right side panel 22 and a bottom frame panel 24. The various panels 18, 20, 22 and 24 surround and define a window aperture 26, within which the louvers 16 are positioned.

Each louver slat 16 is of a length slightly less than the width of the window aperture 26 and has opposing generally flat surfaces 28 bordered by edges 30 and ends 32. Each louver slat 16 is held in place by a pair of pivot pins 34 inserted or embedded into holes 36 drilled or formed in each end 32 of the louver slat 16, Each pivot pin 34 extends laterally outward from the respective end 32. Each of the pivot pins 34 (in the prior art, ordinarily a dowel pin or similar rounded pin) fits into a corresponding receiving cavity 38 in either the left side panel 20 or the right side panel 22 of the frame 14. The fit between the pin 36 and either or both of the holes 36 and the receiving cavity 38 is loose enough that the pin 28 (and the attached louver slat 16 may rotate with respect to the frame 14. The shutter system 12 illustrated in FIG. 1 also includes a louver control lever 40 which is connected by a pivotal connector 42 to the center of one slat edge 30 of each louver slat 16 such that all of the slats 16 will rotate together as the control lever 40 is moved toward either the top panel 18 or the bottom panel 24 of the frame 14. This facilitates opening and closing the louvers 16 to let in more or less light and airflow through the window aperture 26. A lever slot 44 is formed in the surface of the top panel 18 so that the control lever 40 can lie effectively flat with the louvers 16 closed (lying with the slat surfaces 28 parallel to the frame 14).

In conventional shutter assemblies the pivot pins 34 in one of the centrally located louver slats 16 are replaced by a through bolt 46 which extends all the way through the slat 16 and across between the opposing left side panel 20 and right side panel 22. The through bolt 46 has a terminating bolt nut 48 which may be removed in order to disassemble the frame 14. This is necessary for assembly of the shutter subsystem 12 and for tensioning the louvers 16 by adjusting the side pressure on the slats. The bolt 46 and nut 48 may also be disconnected to allow disassembly of the frame for purposes such as replacing a broken louver 16 or malfunctioning pivot pin 34.

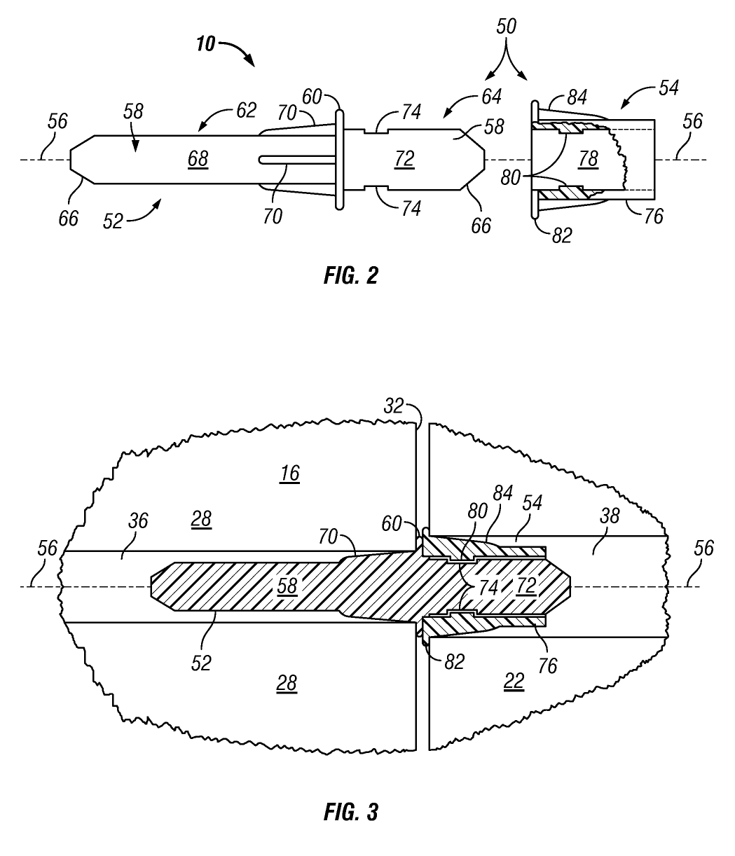

In the preferred embodiment 10 of the present tensioning pin system invention, the conventional pivot pin 34 is replaced by a novel tensioning pin 50, illustrated in FIGS. 2 and 3. The exploded side elevational view of FIG. 2 shows the tensioning pin 50 as having two separable elements, these being a pin member 52 and a ferrule member 54. As is particularly shown in the cross-sectional view of FIG. 3, the pin member 52 and the ferrule member 54 mate together to form the tensioning pin 50 when installed between a louver slat 16 and the frame 14 (either with a left side panel 20 or a right side panel 22). The tensioning pin 50 is generally radially symmetrical about a longitudinal axis 56 and is formed of a generally rigid, but slightly resilient material, such as nylon or a relatively rigid plastic.

The pin member 52 is in the form of an elongated shaft 58 which, although integral in construction, is effectively divided into two distinct sections by a stop ring 60. On one side (left in FIG. 2) of the stop ring 60 is a louver portion 62 while a frame portion 64 is on the opposite end of the shaft 58. As shown in FIG. 3, these portions indicate with which shutter subassembly 12 element the tensioning pin 50 interfaces.

The louver portion 62 includes a tapered end 66 for ease of molding and formation, a cylindrical rod 68 and a plurality (four in the case of the preferred embodiment 10) of tapered seating ribs 70. The seating ribs 70 are intended to engage the inner walls of the receiving aperture 38 (see FIG. 3) and hold the pin member 52 firmly in place with respect to the louver slat 16.

The frame portion 64 includes a cylindrical post 72 also having a tapered tip 66 for extending into the hole 36 (see FIG. 3). The cylindrical post 72 has a slightly greater diameter than the cylindrical rod 68 on the opposite side of the stop ring 60. In the preferred embodiment, an annular catch channel 74 is formed on the cylindrical post 72 at a location offset from the stop ring 60. The ferrule member 54 is adapted to slidably fit over and engage with the pin member 52 when assembled (see FIG. 3).

The ferrule member 54 includes a cylindrical tube 76 defining a center bore 78 extending therethrough. The center bore 78 has a diameter slightly greater than that of the cylindrical post 72 and has an annular protrusion 80 situated on the interior surface. The annular protrusion 80 is adapted to engage and mate with the catch channel 74 when assembled (see FIG. 3) to hold the tension pin 50 together along the axis 56 while allowing rotation of pin member 52 with respect to the ferrule member 54. The surface of the annular protrusion 80 and the catch channel 74 provide the engagement interface between the pin member 52 and the ferrule member 54 and control the relative tension of rotation therebetween. A restraining ring 82 is formed on one end of the ferrule 54 and extends radially beyond the diameter of the tube 76, and has a diameter slightly greater than that of the stop ring 60. A plurality (four in the preferred embodiment) of anchoring ribs 84 are formed on the outside of the cylindrical tube 76 for engaging the interior of the hole 36 when assembled (see FIG. 3).

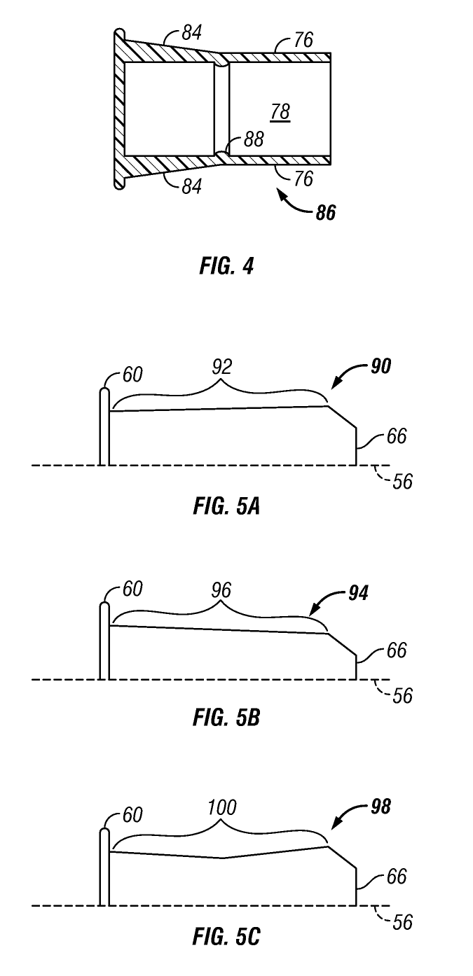

The preferred embodiment of the ferrule 54 has a generally rectangular cross section shaped annular protrusion 80 within the center bore 78, to mate with the catch channel 74 on the cylindrical post 72. FIG. 4 illustrates an alternate ferrule 86 which accomplishes the same purpose but is intended to operate without a catch channel 74. The alternate ferrule 86 includes an annular bead ring 88 which has a rounded “bead” cross section. The annular bead ring 88 provides a small contact ring about the cylindrical post 72 which provides a limited contact zone to minimize binding when the members are rotated with respect to each other. The alternate ferrule 86 is adapted to function particularly with the alternate post members illustrated in FIGS. 5a, 5b and 5c.

FIGS. 5a, 5b and 5c, show alternate versions of the cylindrical post portion of the pin member, each alternative have a gradient on the post surface to change the interface with the alternate ferrule 86. In the illustration, scale is not followed but is shown with greatly exaggerated slopes to illustrate the degree of the gradients, since the actual components exhibit very slight gradients (approximately 0.1 mm or 0.004 in).

A first alternate post member 90 is illustrated in FIG. 5a and has a decrease gradient 92 extending from the tapered tip 66 to the stop ring 60. This means that a greater force is required to insert the first alternate post 90 into the ferrule (either 54 or 86). However, once inserted, the decrease gradient lessens the pressure as a greater degree of engagement occurs. This helps to prevent the engagement from working loose since forcing the members apart requires increased force, which is unlikely to occur during ordinary use. This forms a modified snap fit engagement.

A second alternate cylindrical post 94 is illustrated in FIG. 5b and also has a slight gradient from the tapered tip 66 to the stop ring 60. However, this is in the form of an increase gradient 96 with the second alternate post 94 increasing in thickness as it approaches the stop ring 60. This embodiment uses increased girth to facilitate an increasingly tight sliding fit with the ferrule 54. While the second alternate post 94 does not resist coming apart during use, it has the advantage that the pressure increases with a greater degree of engagement. This results in greater turn resistance, which can be advantageous, as tightening the through bolt 46 further can be used to achieve the desired tension to hold the slats 16 in position. This variant does not involve a snap fit.

A third alternate post 98 is illustrated in FIG. 5c. This includes both of the features of the other alternate post by having a valley gradient 100 which decreases the thickness inwardly form both the tapered tip 66 and the stop ring 60. The valley gradient 100 both helps to prevent disassembly and allows adjusting the tension. Although shown with the nadir of the valley gradient 100 near the center point on the third alternate post 98, this may be modified toward the tapered tip to allow for a greater range on increased tension by forcing the members together to a greater degree. The third alternate post 98 provides both a nap fit and an adjustable tension zone.

The preferred tensioning pin (both portions) is molded from a slightly deformable, but generally rigid plastic such as nylon. It is slightly harder than the typical wood or composite material of the frame 14 so the seating ribs 70 and anchoring ribs 84 will dig into the slat and frame materials to form a relatively firm bond. In the preferred embodiment a reasonable amount of force is needed to push the cylindrical post 72 into center bore 78 to the point that the annular protrusion 80 mates with the catch channel 74. Once engaged, it takes a goodly amount of force to pull the ferrule 54 from the pin member 52, although the pin member 52 readily rotates with respect to the ferrule 54. The snap fit helps to ensure secure installation.

The usual dimensions of the preferred embodiment of the tensioning pin member 52 are a length of 300 mm (1.2 in) with 200 mm being the length of the louver portion 62, and a thickness of 30 mm in the cylindrical rod 68 and 40 mm in the cylindrical post 72. The catch channel 74 has a depth of about 1 mm and the stop ring 60 extends about 8 mm. The ferrule member has length of about 100 mm and outside diameter of about 70 mm. The center bore 78 has a diameter of just greater than 40 mm while the annular protrusion 80 extends inward about 1 mm. The restraining ring 82 has a diameter of about 85 mm.

Of course, different designs of shutter assemblies may require different dimensions and materials. Neither the materials nor the dimensions are critical to the operation of the invention.

It is noted that while the preferred embodiment has the catch channel 74 on the tensioning pin member 52 and the annular protrusion 80 within the ferrule member 54, these could be reversed with similar effect. The same reversal of positions equally applies to the alternate embodiments.

Numerous other variants and modifications of the improved tension pin system 10 of the present invention may be envisioned and implemented. The above discussed embodiments are for exemplary purposes only and the appended claims are to be interpreted as encompassing the true and full spirit and cope of the invention. While various embodiments have been described above, it should be understood that they have been presented by way of example only, and not limitation.

### INDUSTRIAL APPLICABILITY

The improved shutter tension pin 10 of the present invention is adapted for use in a shutter louver assembly 12 or in any similar situation where similar rotation of one element to another is desired. For a typical construction, the frame 14 will be disassembled and awaiting insertion of the louver slats 16. Each of the left side panel 20 and the right side panel 22 will have a series of receiving cavities 38 drilled to correspond to the desired positions of the louver slats 16. The assembler will place a ferrule member 54 into each receiving cavity 38 and secure it by driving it against the frame such that the restraining ring 82 is essentially flush and the anchoring ribs 84 are wedged into the frame material. Similarly, a pin member 50 is driven into the holes 36 formed in each end 32 of each louver slat 16, with the louver portion 62 contained within the hole and the stop ring flush against the end 32 and the seating ribs 70 are firmly wedged into the slat material.

The set of louver slats 16 is then installed into one of the left or right side panels (the top and bottom panels may either already be attached prior to louver seating or added after). The cylindrical post of each tension pin member 52 on the slat 16 is inserted into the corresponding center bore 78 of the ferrule 54 and forced inward until a snap fit is formed with the annular protrusion 80 mating with the catch channel 74. The opposing frame panel is then engaged simultaneously with each of the louver slats 16 in a similar manner and the forced inward until engagement is achieved with the remaining pin members 52 and ferrule members 54. The frame panels are then mechanically or adhesively secured to each other and the resulting shutter louver assembly 12 is complete, with each slat 16 properly spaced and freely rotating with respect to the frame 14 as a result of the tensioning pin members 50.

The tensioning pins 50 maintain proper spacing between the louver slats 16 and the frame members and the rotation is freely maintained since the only engagement is between the cylindrical posts 72 and the center bores 78 of the corresponding elements. This plastic to plastic engagement, restricted by the annular protrusions 80 and the catch channels 74, prevents fouling of the louver rotation. A spacing of at least the combined thickness of the stop ring 60 and the restraining ring 82 is always maintained between the frame 14 and the louver slat 16. The construction is also suited to last and operate indefinitely.

A relatively tight fit between the tensioning pin member 52 and the ferrule member 54 is maintained since completely free rotation is not generally desirable. Frictional resistance to rotation permits the louvers 16 to be held in whatever position the user desires. A girth gradient on the alternate cylindrical posts 90, 94 and 98 helps to maintain the tight fit. Similarly, the relatively tight interface between the annular protrusion 80 and the catch channel 74 helps maintain mutual tension as well as providing a rotational guide.

For the above, and other, reasons, it is expected that the paperless transaction trail system 10 of the present invention will have widespread industrial applicability. Therefore, it is expected that the commercial utility of the present invention will be extensive and long lasting.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. An improved tensioning pin system for shutter louvers, comprising:
an elongated pin member separated by a dividing stop ring into a frame portion and a louver portion for interfacing with an aperture in a shutter louver; and
a ferrule member for engaging with an aperture in a frame member; wherein
one of said pin member and said ferrule member includes an annular catch channel and the other member includes an annular protrusion to engage with said catch channel when said pin member is slid into said ferrule member.

2. The tensioning pin system of claim 1, wherein:
said annular protrusion is formed within a center bore formed in said ferrule member and said annular catch ring is formed on said frame portion.

3. The tensioning pin system of claim 1, wherein:
said elongated pin member is symmetrical about a longitudinal axis.

4. The tensioning pin system of claim 1, wherein:
said louver portion of said pin member is provided with a plurality of seating ribs to engage said aperture in said shutter louver.

5. The tensioning pin system of claim 1, wherein:
said ferrule member is provided with a plurality of anchoring ribs to engage said aperture in said frame portion.

6. The tensioning pin system of claim 1, wherein:
said ferrule member is provided with a restraining ring to limit insertion into said frame portion and to prevent too much engagement with said pin member.

7. A tensioning pin system comprising:
a pin member being generally symmetrical about a longitudinal axis and having an elongated shaft separated by a stop ring into a louver portion and a frame portion having a cylindrical post; and
a ferrule member adapted to slidably mate with said frame member, said ferrule member having a cylindrical tube defining a center bore to fit over said frame portion to snugly engage said frame portion while permitting tensioned mutual rotation therebetween.

8. The tensioning pin of claim 7, wherein
an annular bead ring is provided on the interior of said center bore to provide a limited engagement surface between said ferrule member and said cylindrical post, thereby controlling friction and tension therebetween.

9. The tensioning pin of claim 8, wherein
said cylindrical post is formed to include an increase gradient of its girth from a tapered tip to said stop ring such that slidably mating said pin member with said ferrule member results in greater tension therebetween corresponding with greater overlap between said cylindrical rod and said bead ring.

10. The tensioning pin of claim 8, wherein
said cylindrical post is formed to include a decrease gradient of its girth from a tapered tip to said stop ring such that slidably mating said pin member with said ferrule member results in a snap fit between said cylindrical rod and said bead ring.

11. The tensioning pin of claim 8, wherein
said cylindrical post is formed to include a valley gradient of its girth between tip and said stop ring such that slidably mating said pin member with said ferrule member results in a snap fit near said tapered tip and a zone of greater tension therebetween corresponding with greater overlap between said cylindrical rod and said bead ring in the area approaching said stop ring.

12. The tensioning pin of claim 7, wherein
said pin member includes seating ribs on said louver portion and said ferrule member includes anchoring ribs.

13. The tensioning pin of claim 7, wherein
said stop ring and a retraining ring formed on said ferrule member provide longitudinal spacing between said pin member and said ferrule member.

14. The tensioning pin of claim 7, wherein
said cylindrical post includes an annular catch channel formed thereon; and
said center bore includes an annular protrusion adapted to mate with said catch channel when said cylindrical post is slid into said center bore to a desired degree of overlap.

15. The tensioning pin of claim 14, wherein
the engagement between said annular protrusion and said catch channel forms a rotational interface between said pin member and said ferrule member and the friction between said annular protrusion and said catch channel provides tension to limit the ease of mutual rotation.
